(19) United States
(12) Patent Application Publication
(10) Pub. No.: US 2017/0249077 A1
(43) Pub. Date: Aug. 31, 2017

(54) ELECTRONIC DEVICE AND METHOD FOR CONTROLLING DISPLAY

(71) Applicant: Samsung Electronics Co., Ltd., Gyeonggi-do (KR)

(72) Inventors: Jae-Woo SUH, Seoul (KR); Young-Kyu SEON, Gyeonggi-do (KR); Ga-Jin SONG, Gyeonggi-do (KR); Chae-Whan LIM, Daegu (KR); Byung-Jin JUNG, Gyeonggi-do (KR)

(73) Assignee: Samsung Electronics Co., Ltd.

(21) Appl. No.: 15/437,688

(22) Filed: Feb. 21, 2017

(30) Foreign Application Priority Data
Feb. 29, 2016 (KR) 10-2016-0019556

(51) Int. Cl. G06F 3/0488; G06F 3/041; G06F 17/24

(52) U.S. Cl. CPC G06F 3/04883; G06F 17/245; G06F 3/041; G06F 2203/04105

(57) ABSTRACT

Disclosed is an electronic device and method for controlling a display in response to a user input. The electronic device includes a communication interface, a memory configured to store a table related to a graphic object, a display, and a processor which obtains a user input, transmits motion information corresponding to the user input to an external electronic device using the communication interface, obtains image information corresponding to the motion information and screen information of the external electronic device from the external electronic device, determines the graphic object based on the image information, and displays the graphic object and the screen information together.

### PRIORITY

This application claims priority under 35 U.S.C. §119(a) to a Korean Patent Application filed in the Korean Intellectual Property Office on Feb. 19, 2016 and assigned Serial No. 10-2016-0019556, the entire disclosure of which is incorporated herein by reference.

### BACKGROUND

1. Field of the Disclosure

The present disclosure generally relates to an electronic device, and more particularly, to an apparatus and method for controlling a display in response to a user input.

2. Description of the Related Art

Recently, various services and additional functions provided in electronic devices have been expanded. To improve the utility value of electronic devices and meet various demands of users, common carriers or electronic device manufacturers have developed electronic devices to provide various functions and to differentiate electronic devices from electronic devices of other companies.

The various functions include a function for providing cloud computing in which a resource of a server is used from a remote place over an ultra-high-speed network. A lot of companies may provide some of cloud resources to users through a cloud service, and the cloud computing is continuously developed.

A virtual desktop interface (VDI) is intended to efficiently manage a virtual machine and a resource of the server, and a manager generates and manages the virtual machine through a monitoring tool, such that a user may efficiently use the resources of the server through an electronic device.

In addition, an electronic device controls a display in response to a user input. For example, conventionally, there are a first scheme in which an electronic device of a user displays a mouse cursor on the display and transmits coordinates information of the mouse cursor to a server, a second scheme in which the electronic device hides the mouse cursor of the electronic device, receives an image and coordinates information of a mouse cursor of the server, and displays the received image and coordinates information on a screen of the electronic device, or a third scheme in which both the mouse cursor of the electronic device and the mouse cursor of the server are displayed on the screen.

However, in the first scheme, the user may not sense the shape of the mouse cursor being changed in the server while the latency of the motion of the mouse cursor the user feels is reduced; in the second scheme, the shape of the mouse cursor being changed in the server may be identical, but the screen of the server including the motion of the mouse cursor has to be transmitted continuously to the electronic device, increasing the latency of the motion of the mouse cursor the user feels. In the third scheme, the user may sense the shape of the mouse cursor, but two shapes of the mouse cursor are expressed, causing confusion.

Thus, there is a need for allowing a user to feel a motion of the mouse cursor as a minimum latency and to sense a change in the shape of the mouse cursor in the server, suitable for a situation.

### SUMMARY

An aspect of the present disclosure provides an electronic device and a server which may have different operating systems (OSs). In the electronic device and the server, one or more applications may exist on the respective OSs to deliver and process system level information through a network and to express the information on a screen.

According to an aspect of the present disclosure, there is provided an electronic device including a memory configured to store a table related to a graphic object, a display, and a processor, configured to obtain a user input, to transmit motion information corresponding to the user input to an external electronic device, to obtain image information corresponding to the motion information and screen information of the external electronic device from the external electronic device, to determine the graphic object based on the image information, and to display the graphic object and the screen information together.

According to another aspect of the present disclosure, there is provided a method for controlling a display in response to a user input in an electronic device according to various embodiments of the present disclosure includes transmitting motion information corresponding to a user input to an external electronic device, obtaining image information corresponding to the motion information and screen information of the external electronic device, determining the graphic object based on the image information, and displaying a graphic object and the screen information together.

According to an aspect of the present disclosure, there is provided an electronic device including a communication interface, a memory, a display, and a processor, configured to send a request for at least one application to an external electronic device through the communication interface, to receive first image information corresponding to a first image related to execution of the at least one application from the external electronic device, to display the first image generated at least based on the first image information through the display, to obtain a user input with respect to the displayed first image, to transmit motion information corresponding to the user input to the external electronic device, to receive second image information, which is generated at least based on the motion information and corresponds to a second image related to the user input, from the external electronic device, and to display the second image in relation to the first image at least based on the second image information through the display.

### BRIEF DESCRIPTION OF THE DRAWINGS

The above and other aspects, features and advantages of certain embodiments of the present disclosure will be more apparent from the following description, taken in conjunction with the accompanying drawings, in which:

FIG. 1 illustrates an electronic device in a network environment according to an embodiment of the present disclosure;

FIG. 2 is a block diagram of an electronic device according to an embodiment of the present disclosure;

FIG. 3 is a block diagram of a programming module according to an embodiment of the present disclosure;

FIG. 4 illustrates a system for controlling a display of an electronic device in response to a user input according to an embodiment of the present disclosure;

FIG. 5 is a flowchart of a process for controlling a display of an electronic device in response to a user input according to an embodiment of the present disclosure;

FIG. 6 is a flowchart of a process for controlling a display of an electronic device in response to a user input according to an embodiment of the present disclosure;

FIG. 7A illustrates movement of a mouse cursor on a display of an electronic device;

FIG. 7B illustrates generation of image information corresponding to motion information of a mouse cursor moved in an electronic device by a server;

FIG. 7C illustrates a screen displaying image information received from a server; and

FIG. 8 illustrates a process of displaying a graphic object and screen information according to an embodiment of the present disclosure.

Throughout the drawings, like reference numerals will be understood to refer to like parts, components, and structures.

### DETAILED DESCRIPTION

Hereinafter, various embodiments of the present disclosure will be disclosed with reference to the accompanying drawings. However, embodiments and terms used therein are not intended to limit the present disclosure to particular embodiments, and the present disclosure should be construed as including various modifications, equivalents, and/or alternatives according to the embodiments of the present disclosure.

Singular forms are intended to include the plural forms as well, unless the context clearly indicates otherwise. In the present disclosure, expressions such as “A or B,” “at least one of A or/and B,” or “one or more of A or/and B” may include all possible combinations of together listed items. Expressions such as “first,” “second,” “primarily,” or “secondary,” used herein may represent various elements regardless of order and/or importance and do not limit corresponding elements. When it is described that an element (such as a first element) is “operatively or communicatively coupled with/to” or “connected” to another element (such as a second element), the element can be directly connected to the other element or can be connected to the other element through another element (e.g., a third element).

The expression “configured to (or set)” used in the present disclosure may be used interchangeably with, for example, “suitable for,” “having the capacity to,” “adapted to,” “made to,” “capable of,” or “designed to” according to a situation. Alternatively, in some situations, the expression “apparatus configured to” may mean that the apparatus “can” operate together with another apparatus or component. For example, a phrase such as “a processor configured (or set) to perform A, B, and C” may refer to a dedicated processor (e.g., an embedded processor) for performing a corresponding operation or a generic-purpose processor (such as a CPU or an application processor) that can perform a corresponding operation by executing at least one software program stored in a memory device.

An electronic device according to various embodiments of the present disclosure may include at least one of, for example, a smartphone, a tablet personal computer (PC), a mobile phone, a video phone, an electronic-book (e-book) reader, a desktop PC, a laptop PC, a netbook computer, a workstation, a server, a personal digital assistant (PDA), a portable multimedia player (PMP), an MP3 player, a mobile medical equipment, a camera, and a wearable device. Examples of the wearable device may include at least one of an accessory type (e.g., a watch, a ring, a bracelet, an anklet, a necklace, glasses, contact lenses, head-mounted device (HMD), etc.), a fabric or cloth-integrated type (e.g., electronic clothing, etc.), a body-attached type (e.g., a skin pad, a tattoo, etc.), a body implanted type (e.g., an implantable circuit, etc.), and so forth.

In some embodiments, the electronic device may include, for example, a television (TV), a Digital Video Disk (DVD) player, audio equipment, a refrigerator, an air conditioner, a vacuum cleaner, an oven, a microwave oven, a washing machine, an air cleaner, a set-top box, a home automation control panel, a security control panel, a TV box (e.g., HomeSync™ of Samsung, TV™ of Apple, or TV™ of Google), a game console, an electronic dictionary, an electronic key, a camcorder, and an electronic frame.

In other embodiments, the electronic device may include at least one of various medical equipment (for example, magnetic resonance angiography (MRA), magnetic resonance imaging (MRI), computed tomography (CT), an imaging device, or an ultrasonic device), a navigation system, a global positioning system (GPS) receiver, an event data recorder (EDR), a flight data recorder (FDR), a vehicle infotainment device, electronic equipment for ships (e.g., a navigation system and gyro compass for ships), avionics, a security device, a vehicle head unit, an industrial or home robot, an automatic teller machine (ATM), a Point of Sales (POS) terminal, Internet of things (IoT) device (e.g., electric light bulb, various sensors, electricity or gas meters, sprinkler devices, fire alarm devices, thermostats, streetlights, toasters, exercise machines, hot-water tanks, heaters, boilers, and so forth).

According to some embodiments, the electronic device may include a part of a furniture, building/structure or a part of a vehicle, an electronic board, an electronic signature receiving device, a projector, and various measuring instruments (e.g., a water, electricity, gas, electric wave measuring device, etc.).

According to various embodiments, the electronic device may be flexible or may be a combination of two or more of the above-described various devices. The electronic device is not limited to the aforementioned devices. Herein, the term “user” used in the present disclosure may refer to a person who uses the electronic device or a device using the electronic device.

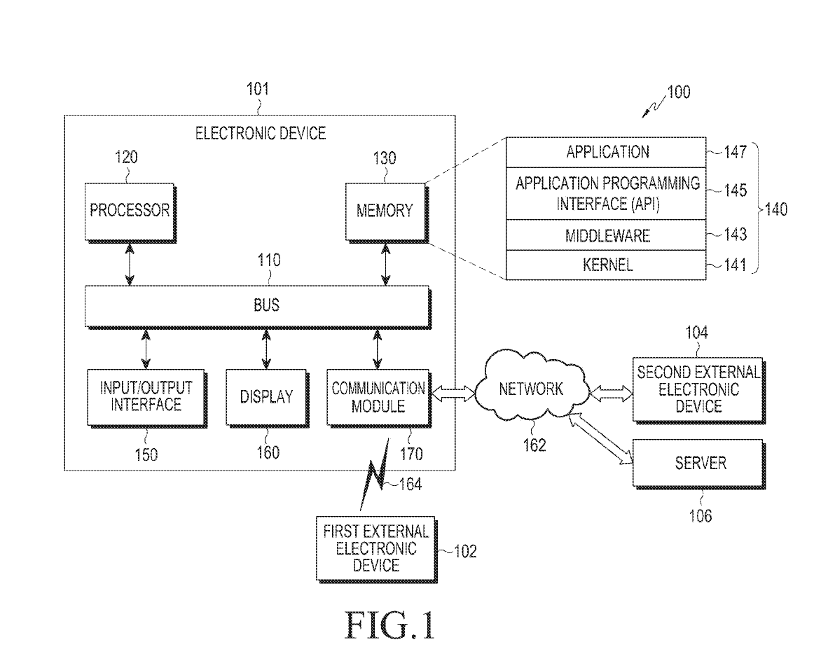

Referring to FIG. 1, an electronic device 101 in a network environment 100 according to an embodiment of the present disclosure is disclosed.

The electronic device 101 may include a bus 110, a processor 120, a memory 130, an input/output (I/O) interface 150, a display 160, and a communication module 170. The electronic device 101 may omit at least one of the foregoing elements or may include other elements. The bus 110 may include a circuit for connecting, e.g., the elements 110 to 170 and delivering communication (e.g., a control message or data) between the elements 110 to 170. The processor 120 may include one or more of a central processing unit (CPU), an application processor (AP), and a communication processor (CP). The processor 120 performs operations or data processing for control and/or communication of, for example, at least one other element of the electronic device 101.

The memory 130 may include a volatile and/or nonvolatile memory. The memory 130 may store, for example, instructions or data associated with at least one other element of the electronic device 101. The memory 130 may store software and/or a program 140. The program 140 may include at least one of, for example, a kernel 141, middleware 143, an application programming interface (API) 145, and/or an application program (or “application”) 147, and the like. At least some of the kernel 141, the middleware 143, and the API 145 may be referred to as an operating system (OS). The kernel 141 may control or manage, for example, system resources (e.g., the bus 110, the processor 120, the memory 130, etc.) used to execute operations or functions implemented in other programs (e.g., the middleware 143, the API 145, or the application program 147). The kernel 141 provides an interface through which the middleware 143, the API 145, or the application program 147 access separate components of the electronic device 101 to control or manage the system resources.

The middleware 143 may work as an intermediary for allowing, for example, the API 145 or the application 147 to exchange data in communication with the kernel 141. In addition, the middleware 143 may process one or more task requests received from the application 147 based on priorities. For example, the middleware 143 may give a priority for using a system resource (e.g., the bus 110, the processor 120, the memory 130, etc.) of the electronic device 101 to at least one of the applications 147, and may process the one or more task requests. The API 145 is an interface used for the application 147 to control a function provided by the kernel 141 or the middleware 143, and may include, for example, at least one interface or function (e.g., an instruction) for file control, window control, image processing or character control. The I/O interface 150 may deliver, for example, an instruction or data input from a user or another external device to other component(s) of the electronic device 101, or output an instruction or data received from other component(s) of the electronic 101 to a user or another external device.

The display 160 may include, for example, a liquid crystal display (LCD), a light emitting diode (LED) display, an organic light emitting diode (OLED) display, a microelectromechanical system (MEMS) display, or an electronic paper display. The display 160 may, for example, display various contents (e.g., a text, an image, video, an icon, and/or a symbol, etc.) to users. The display 160 may include a touch screen, and receives a touch, a gesture, proximity, or a hovering input, for example, by using an electronic pen or a part of a body of a user. The communication module 170 establishes communication between the electronic device 101 and an external device (e.g., a first external electronic device 102, a second external electronic device 104, or a server 106). For example, the communication module 170 may be connected to a network 162 through wireless communication or wired communication to communicate with the second external electronic device 104 or the server 106.

The wireless communication may include cellular communication using at least one of long term evolution (LTE), LTE-advanced (LTE-A), code division multiple access (CDMA), wideband CDMA (WCDMA), a universal mobile telecommunication system (UMTS), wireless broadband (WiBro), or global system for mobile communications (GSM)). The wireless communication may include at least one of wireless fidelity (WiFi), Bluetooth, Bluetooth low energy (BLE), Zigbee, near field communication (NFC), magnetic secure transmission (MST), radio frequency (RF), and a body area network (BAN). According to an embodiment, the wireless communication may include GNSS. The GNSS may include, for example, at least one of a global positioning system (GPS), a global navigation satellite system (Glonass), a Beidou navigation satellite system (Beidou), and Galileo, the European global satellite-based navigation system. Hereinbelow, “GPS” may be used interchangeably with “GNSS”. The wired communication may include, for example, at least one of USB, HDMI, recommended standard 232 (RS-232), power line communication, and plain old telephone service (POTS). The network 162 may include a telecommunications network, for example, at least one of a computer network (e.g., a local area network (LAN) or a wide area network (WAN)), Internet, and a telephone network.

Each of the first external electronic device 102 and the second external electronic device 104 may be a device of the same type as or a different type than the electronic device 101. According to various embodiments of the present disclosure, some or all of the operations performed by the electronic device 101 may be performed in another electronic device or a plurality of electronic devices 102 or 104, or the server 106. When the electronic device 101 has to perform a function or a service automatically or at a request, the electronic device 101 may request the electronic devices 102 or 104 or the server 106 to perform at least some functions associated with the function or the service instead of or in addition to executing the function or the service. The electronic device 102 or 104 or the server 106 may execute the requested function or additional function and deliver the execution result to the electronic device 101. The electronic device 101 may then process or further process the received result to provide the requested function or service. To this end, for example, cloud computing, distributed computing, or client-server computing may be used.

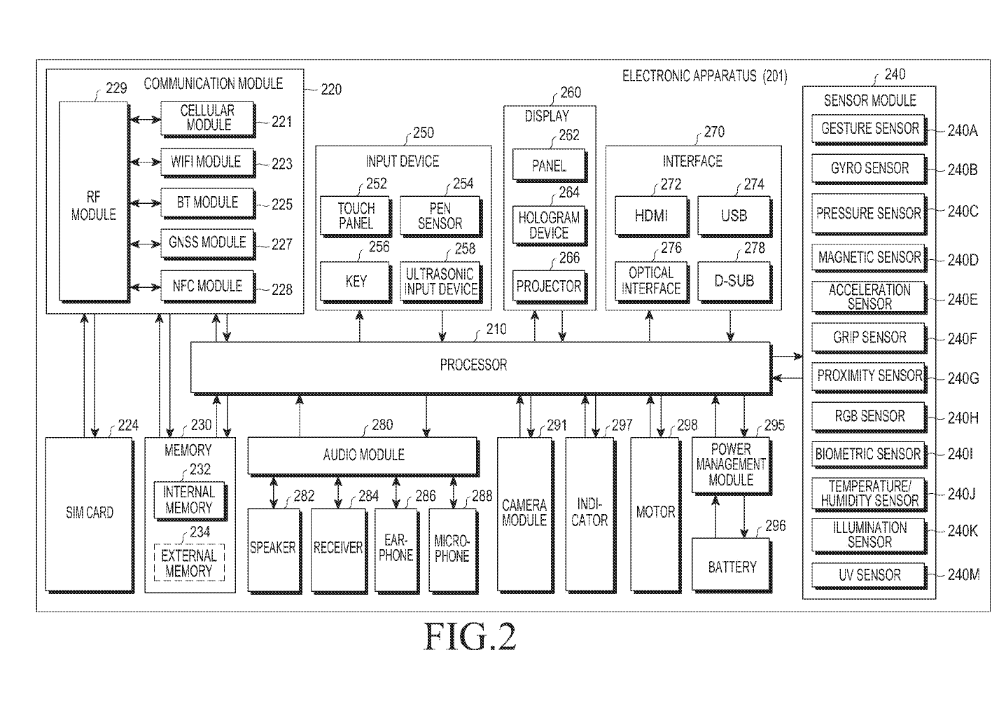

FIG. 2 is a block diagram of an electronic device 201 according to an embodiment of the present disclosure.

The electronic device 201 may form the entire electronic device 101 illustrated in FIG. 1 or a part of the electronic device 101 illustrated in FIG. 1. The electronic device 201 may include one or more processors (e.g., application processors (APs)) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210 controls multiple hardware or software components connected to the processor 210 by driving an Operating System (OS) or an application program, and performs processing and operations with respect to various data. The processor 210 may be implemented with, for example, a system on chip (SoC). The processor 210 may include a GPU and/or an image signal processor. The processor 210 may include at least some of the elements illustrated in FIG. 2 (e.g., a cellular module 221). The processor 210 loads an instruction or data received from at least one of other elements (e.g., a non-volatile memory) into a volatile memory to process the instruction or data, and stores result data in the non-volatile memory.

The communication module 220 may have a configuration that is the same as or similar to the communication module 170. The communication module 220 may include, for example, the cellular module 221, a WiFi module 223, a Bluetooth (BT) module 225, a GNSS module 227, a near field communication (NFC) module 228, and a radio frequency (RF) module 229. The cellular module 221 may provide, for example, a voice call, a video call, a text service, or an Internet service over a communication network. The cellular module 221 identifies and authenticates the electronic device 201 in a communication network by using the SIM 224 (e.g., a SIM card). The cellular module 221 performs at least one of the functions that may be provided by the processor 210. The cellular module 221 may include a communication processor (CP). At least some (e.g., two or more) of the cellular module 221, the WiFi module 223, the BT module 225, the GNSS module 227, and the NFC module 228 may be included in one integrated chip (IC) or IC package. The RF module 229 may, for example, transmit and receive a communication signal (e.g., an RF signal). The RF module 229 may include a transceiver, a power amplifier module (PAM), a frequency filter, a low noise amplifier (LNA), or an antenna. At least one of the cellular module 221, the WiFi module 223, the BT module 225, the GNSS module 227, and the NFC module 228 may transmit and receive an RF signal through the separate RF module. The SIM 224 may, for example, include a card including a SIM or an embedded SIM, and may include unique identification information (e.g., an integrated circuit card identifier (ICCID) or subscriber information (e.g., an international mobile subscriber identity (IMSI)).

The memory 230 (e.g., the memory 130) may, for example, include an internal memory 232 and/or an external memory 234. The internal memory 232 may, for example, include at least one of a volatile memory (e.g., dynamic random access memory (DRAM), static RAM (SRAM), synchronous dynamic RAM (SDRAM), and a non-volatile memory (e.g., one time programmable read only memory (OTPROM), programmable ROM (PROM), erasable and programmable ROM (EPROM), electrically erasable and programmable ROM (EEPROM), mask ROM, flash ROM, a flash memory, and a solid state drive (SSD). The external memory 234 may further include flash drive, for example, compact flash (CF), secure digital (SD), micro-SD, mini-SD, extreme Digital (xD), a multi-media card (MMC), or a memory stick. The external memory 234 may be functionally or physically connected with the electronic device 201 through various interfaces.

The sensor module 240 measures physical quantities or senses an operation state of the electronic device 201 to convert the measured or sensed information into an electric signal. The sensor module 240 may, for example, include at least one of a gesture sensor 240A, a gyro sensor 240B, a pressure sensor 240C, a magnetic sensor 240D, an acceleration sensor 240E, a grip sensor 240F, a proximity sensor 240G, a color sensor 240H (e.g., an RGB sensor), a biometric sensor 240I, a temperature/humidity sensor 240J, an illumination sensor 240K, and a ultraviolet (UV) sensor 240M. Additionally or alternatively, the sensor module 240 may include an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one sensor included therein. The electronic device 201 may further include a processor configured to control the sensor module 240 as part of or separately from the processor 210, to control the sensor module 240 during a sleep state of the processor 210.

The input device 250 may include, for example, a touch panel 252, a (digital) pen sensor 254, a key 256, or an ultrasonic input device 258. The touch panel 252 may use at least one of a capacitive type, a resistive type, an IR type, or an ultrasonic type. The touch panel 252 may further include a control circuit. The touch panel 252 may further include a tactile layer to provide tactile reaction to the user. The (digital) pen sensor 254 may include a recognition sheet which is a part of the touch panel 252 or a separate recognition sheet. The key 256 may also include a physical button, an optical key, or a keypad. The ultrasonic input device 258 senses ultrasonic waves generated by an input means through a microphone 288 and checks data corresponding to the sensed ultrasonic waves.

The display 260 may include a panel 262, a hologram device 264, a projector 266, and/or a control circuit for controlling them. The panel 262 may be implemented to be flexible, transparent, or wearable. The panel 262 may be configured with the touch panel 252 in one module. The panel 262 may include a pressure sensor (or a “force sensor”) capable of measuring a strength of a pressure by a user's touch. The pressure sensor may be implemented integrally with the touch panel 252 or may be implemented as one or more sensors separate from the touch panel 252. The hologram device 264 shows a stereoscopic image in the air by using interference of light. The projector 266 displays an image onto an external screen through projection of light. The screen may be positioned inside or outside the electronic device 201. The interface 270 may include a high-definition multimedia interface (HDMI) 272, a universal serial bus (USB) 274, an optical communication 276, or a D-subminiature 278. The interface 270 may be included in the communication module 170 illustrated in FIG. 1. Additionally or alternatively, the interface 270 may include, for example, a mobile high-definition link (MHL) interface, an SD card/MMC interface, or an infrared data association (IrDA) standard interface.

The audio module 280 bi-directionally converts sound and an electric signal. At least one element of the audio module 280 may be included in the input/output interface 150 illustrated in FIG. 1. The audio module 280 processes sound information input or output through speaker 282, receiver 284, earphone 286, or microphone 288. The camera module 291 is, for example, a device capable of capturing a still image or a moving image, and may include one or more image sensors (e.g., a front sensor or a rear sensor), a lens, an image signal processor (ISP), or a flash (e.g., an LED, a xenon lamp, etc.). The power management module 295 manages power of the electronic device 201, and may include a power management integrated circuit (PMIC), a charger IC, or a battery gauge. The PMIC may have a wired and/or wireless charging scheme. The wireless charging scheme includes a magnetic-resonance type, a magnetic induction type, and an electromagnetic type, and for wireless charging, an additional circuit, for example, a coil loop, a resonance circuit, or a rectifier may be further included. The battery gauge measures the remaining capacity of the battery 296 or the voltage, current, or temperature of the battery 296 during charging. The battery 296 may include a rechargeable battery and/or a solar battery.

The indicator 297 displays a particular state, for example, a booting state, a message state, or a charging state, of the electronic device 201 or a part thereof (e.g., the processor 210). The motor 298 converts an electric signal into mechanical vibration or generates vibration or a haptic effect. The electronic device 201 may include a device for supporting mobile TV (e.g., a GPU) to process media data according to a standard such as digital multimedia broadcasting (DMB), digital video broadcasting (DVB), or mediaFlo™. Each of the foregoing elements described herein may be configured with one or more components, names of which may vary with a type of the electronic device. In various embodiments, some components of the electronic device may be omitted or may further include other elements, and some of the components may be coupled to form one entity and identically perform functions of the components before being coupled.

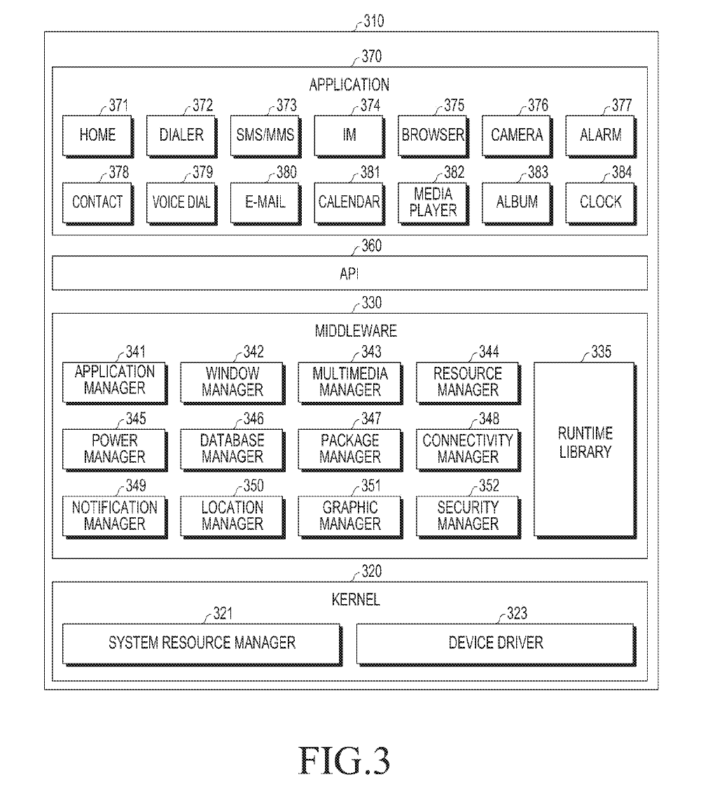

FIG. 3 is a block diagram of a programming module according to an embodiment of the present disclosure.

According to an embodiment, a programming module 310 may include an OS for controlling resources associated with an electronic device (e.g., the electronic device 101) and/or various applications or programs 147) executed on the OS. The OS may include Android™, iOS™, Windows™, Symbian™, Tizen™, or Bada™ Referring to FIG. 3, the programming module 310 may include a kernel 320, middleware 330, an application programming interface (API) 360, and/or an application 370. At least a part of the programming module 310 may be preloaded on an electronic device or may be downloaded from an external electronic device 102 or 104 or the server 106.

The kernel 320 may include a system resource manager 321 and/or a device driver 323. The system resource manager 321 may perform control, allocation, retrieval of system resources, and so forth. The system resource manager 321 may include a process management unit, a memory management unit, or a file system management unit. The device driver 323 may include, for example, a display driver, a camera driver, a Bluetooth driver, a shared memory driver, a USB driver, a keypad driver, a WiFi driver, an audio driver, or an inter-process communication (IPC) driver. The middleware 330 may provide functions that the application 370 commonly requires or provide various functions to the application 370 through the API 360 to allow the application 370 to use a limited system resource in an electronic device. The middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses to add a new function through a programming language while the application 370 is executed. The runtime library 335 performs input/output management, memory management, or calculation function processing. The application manager 341 manages a life cycle of the applications 370. The window manager 342 manages a GUI resource used in a screen. The multimedia manager 343 recognizes a format necessary for playing media files and performs encoding or decoding on a media file by using a codec appropriate for a corresponding format. The resource manager 344 manages a source code or a memory space of the applications 370. The power manager 345 manages a battery or power and provides power information necessary for an operation of the electronic device. The power manager 345 may operate with basic input/output system (BIOS). The database manager 346 generates, searches or changes a database used for at least one application among the applications 370. The package manager 347 manages the installation or update of an application distributed in a package file format.

The connectivity manager 348 manages a wireless connection. The notification manager 349 provides an event, e.g., an arriving message, an appointment, proximity notification, etc. The location manager 350 manages location information of an electronic device. The graphic manager 351 manages a graphic effect to be provided to a user or a user interface relating thereto. The security manager 352 provides system security or user authentication.

The middleware 330 may further include a telephony manager for managing a voice or video call function of the electronic device or a middleware module forming a combination of functions of the above-described components. The middleware 330 provides a module specified for each type of an OS. Additionally, the middleware 330 may delete some of existing elements or add new elements dynamically. The API 360 may be provided as a set of API programming functions with a different configuration according to the OS. In the case of Android™ or iOS™, for example, one API set may be provided by each platform, and in the case of Tizen™, two or more API sets may be provided.

The application 370 may include one or more applications capable of providing a function, for example, a home application 371, a dialer application 372, a short messaging service/multimedia messaging service (SMS/MMS) application 373, an instant message (IM) application 374, a browser application 375, a camera application 376, an alarm application 377, a contact application 378, a voice dial application 379, an e-mail application 380, a calendar application 381, a media player application 382, an album application 383, a clock application 384, a health care application (e.g., an application for measuring an exercise amount, a blood sugar level, etc.), or an environment information providing application (e.g., an application for providing air pressure, humidity, or temperature information or the like).

The application 370 may further include an information exchange application supporting information exchange between the electronic device and an external electronic device. The information exchange application may include, for example, a notification relay application for transferring specific information to the external electronic device or a device management application for managing the external electronic device. For example, the notification relay application may deliver notification information generated in another application of the electronic device to an external electronic device or may receive notification information from the external electronic device and provide the notification information to the user.

The device management application may manage (e.g., install, remove, or update) a function (e.g., turn on/turn off of an external electronic device itself (or a part thereof) or control of brightness (or resolution) of a display) of an external device communicating with the electronic device, a service provided by an application operating in an external electronic device or provided by the external electronic device (e.g., a call service or a message service). The application 370 may include an application (e.g., device health care application of mobile medical equipment) designated according to an attribute of the external electronic device. The application 370 may include an application received from the external electronic device. The at least a part of the programming module 310 may be implemented (e.g., executed) by software, firmware, hardware (e.g., the processor 210), or a combination of two or more of them, and may include, for example, modules, programs, routines, sets of instructions, or processes for performing one or more functions.

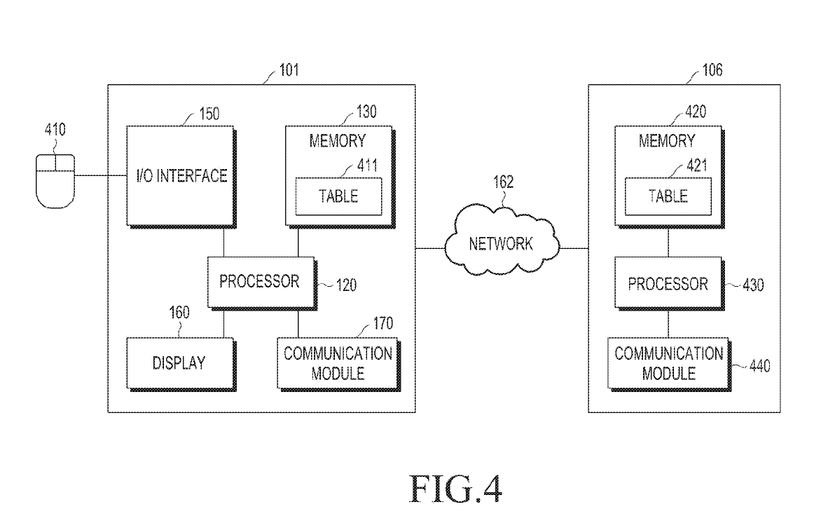

FIG. 4 illustrates a system for controlling a display of an electronic device in response to a user input according to an embodiment of the present disclosure.

Referring to FIG. 4, the system for controlling a display of an electronic device in response to a user input may include an electronic device 101, a server 106, and a network 162 that provides communication between the electronic device 101 and the server 106.

According to an embodiment of the present disclosure, the electronic device 101 may include the I/O interface 150, the memory 130, the processor 120, the display 160, and the communication module 170. The server 106 may include a memory 420, a processor 430, and a communication module 440. Each of the components of FIG. 4 performs at least one function or operation performed by its corresponding component of FIG. 1. According to an embodiment of the present disclosure, the I/O interface 150 manages an input of the electronic device 101, and receives a user input through a keyboard, a touch pad, a mouse 410, etc., connected with the electronic device 101. The user input may be of a form that may by processed by the processor 120 and the memory 130.

According to an embodiment of the present disclosure, the processor 120 controls overall operations of the electronic device 101, and may include one or more of a CPU, an AP, and a CP. The processor 120 processes information received by the I/O interface 150 and the communication module 170.

In addition, the communication module 170 manages communication with an external electronic device, such as the server 106 and the network 162, and establishes communication. For example, the communication module 170 may communicate with an external device connected to a network through wireless communication and wired communication.

According to an embodiment of the present disclosure, the memory 130 may include a volatile and/or nonvolatile memory. The memory 130 may store instructions or data associated with at least one another element of the electronic device 101. For example, the memory 130 may store software or a program. The program may include a kernel, middleware, an application programming interface, etc., and some of them may be referred to as an OS.

According to an embodiment of the present disclosure, the memory 130 stores a table 411 associated with a graphic object displayed on the display 160. The table 411 may include at least one graphic object corresponding to matching information (or an identifier) included in image information received from the server 106. The table 411 may include at least one of at least one graphic object, hotspot information regarding each graphic object, image type information, and a matching number (or an identifier) of each graphic object, depending on a type of a user input inputted through the display 160. For example, if the user input is an input generated by a cursor of a mouse 410, the table 411 may include a cursor number of the mouse, a cursor image corresponding to the cursor number, hotspot information of the cursor, and image type information (e.g., cursor type information). The cursor image may include an application displayed on the display 160 or different images when being located in an edge of a window. For example, if the user input is an input generated by a touch, the table 411 may include information indicating a pressure (or strength) of a touch, a cursor image corresponding to the pressure, and hotspot information of the cursor. For example, the table 411 is as shown in Table 1.

TABLE 1

| Cursor Number | Strength | Cursor Image | Hotspot Information (x, y) |
|---|---|---|---|
| 100 | 1 | [symbol] | (0, 30) |
| 101 | 2 | [symbol] | (15, 15) |
| 107 | 3 | [symbol] | (0, 15) |

Table 1 shows an example of a case where a size of a cursor image is 30×30, in which hotspot information (0, 0) indicates coordinates of a left bottom of each cursor image and hotspot information (30, 30) indicates coordinates of a right top of each cursor image.

For example, if a matching number (e.g., a cursor number) included in image information received from the server 106 is 100, the processor 120 may display a cursor image having the cursor number 100 on the display 160 based on hotspot information; if the matching number is 101, the processor 120 displays a cursor image having a cursor number 101 on the display 160 based on at least one of hotspot information and image type information; and if a matching number is 107, the processor 120 displays a cursor image having a cursor number 107 on the display 160 based on hotspot information.

The processor 120 obtains a user input and transmits motion information corresponding to the user input to an external electronic device by using the communication module. The processor 120 is configured to obtain a user input through the display 160, and the user input may include at least one of a cursor and a touch generated through the mouse 410. The processor 120 obtains a user input based on a user's touch through the display 160 or obtains a user input through the mouse 410 connected to the I/O interface 150. The processor 120 obtains an input generated by the cursor and an input generated by the touch through the mouse 410 at the same time. For example, if the user input is an input generated by the mouse 410, the motion information may include information about coordinates of the cursor moving on the display 160, and if the user input is an input made through the touch, the motion information may include information indicating a pressure generated by the touch on the display 160. The processor 120 obtains information about coordinates of the cursor moving in real time in response to a motion of the cursor. If the touch on the display 160 is input, the processor 120 senses a touched point and a pressure at the touched point (e.g., a touch pressure) and obtains coordinates information and pressure values corresponding to the sensing. The motion information may include not only a user input made using a motion of a cursor and a pressure of a touch, but also various signals (e.g., a user's biometric signal, an external signal, etc.) input to control the electronic device 101.

The processor 120 transmits motion information corresponding to the obtained user input to an external electronic device (e.g., the server 106). The processor 120 obtains image information corresponding to the motion information transmitted to the server 106 and screen information of the external electronic device from the server 106, and determines the graphic object based on the image information. The processor 120 then displays the graphic object and the screen information on the display 160 together. The image information obtained from the server 106 may include a matching number for a graphic object to be displayed on the display 160 based on the transmitted motion information. The image information may include at least one of at least one graphic object, hotspot information regarding each graphic object, image type (class) information, and a matching number (or an identifier) of each graphic object, depending on a type of a user input inputted through the display 160.

The processor 120 may be configured to determine a graphic object corresponding to a matching number included in the obtained image information from a table. The processor 120 selects a corresponding graphic object from the table based on at least one of at least one graphic object, hotspot information regarding each graphic object, image type information, and a matching number of each graphic object. For example, if a graphic object corresponding to a matching number included in the obtained image information does not exist in the table, the processor 120 may be configured to send a request for a graphic object for the obtained image information to the server and to store the graphic object received in response to the request in the table.

The obtained image information may include at least one of hotspot information and image type information, and the hotspot information may indicate information about a reference pixel of a graphic object corresponding to the obtained image information. The image type information is identified by a form of an image of a cursor agreed to in advance between the electronic device 101 and the server 106, and may include various types such as an arrow type in which a left top is sharp, an arrow type in which an edge and a line are adjustable, a finger type, etc. For example, if the image type is a sharp left-top arrow type, hotspot information may be (0, 0); if the image type is an edge-and-line-adjustable arrow type, the hotspot information may be (20, 20); and if the image type is a finger type, the hotspot information may be (30, 30). The table may include at least one graphic object, hotspot information about each graphic object, and a matching number of each graphic object, depending on a type of the user input.

The processor 120 is configured to decode the obtained screen information, to load the decoded screen information on a first layer, to load the determined graphic object on a second layer, and to overlappingly display the loaded first layer and second layer on the display 160 in real time. The processor 120 generates screen information to be displayed on the display 160 by overlapping the second layer onto the loaded first layer.

The processor 120 sends a request for at least one application to the server 106 through the communication module 170 and receives first image information corresponding to a first image related to execution of the at least one application from the server 106. The processor 120 sends a request for at least one application to be executed by the electronic device 101 to an external electronic device (e.g., the server 106) and receives first image information corresponding to a first image related to execution of the requested application from the server 106. The processor 120 displays a first image generated at least based on the first image information on the display 160.

The processor 120 obtains a user input with respect to the displayed first image, transmits motion information corresponding to the user input to the server 106, and receives second image information which is generated at least based on the motion information and corresponds to a second image related to the user input. The processor 120 may be configured to obtain the user input through the first image displayed on the display 160. The processor 120 obtains a user input based on a user's touch through the first image displayed on the display 160 or obtains a user input through the mouse 410 connected to the I/O interface 150. The processor 120 may simultaneously obtain a cursor generated by the mouse 410 and an input generated by a touch through the first image displayed on the display 160. The processor 120 obtains information about coordinates of the cursor moving in real time in response to a motion of the cursor on the displayed first image. If a touch on the first image is input, the processor 120 senses a touched point and a pressure at the touched point (e.g., a touch pressure) and obtains coordinates information and pressure values corresponding to the sensing.

The processor 120 transmits motion information corresponding to the user input inputted on the displayed first image to the server 106 through the network 162. The server 106 generates the second image information corresponding to the second image at least based on the received motion information and transmits the generated second image information to the electronic device 101. The processor 120 obtains the second image information regarding the second image corresponding to the transmitted motion information from the server 106 and displays the second image in relation to the first image at least based on the second image information. The second image information obtained from the server 106 may include a matching number for a graphic object to be displayed on the display 160 based on the transmitted motion information. The second image information may include at least one of at least one graphic object, hotspot information regarding each graphic object, image type information, and a matching number (or an identifier) of each graphic object, depending on a type of a user input inputted through the display 160.

The processor 120 selects a corresponding graphic object from the table 411 based on at least one of at least one graphic object, hotspot information regarding each graphic object, and a matching number of each graphic object, which are included in the received second image information. For example, if a graphic object corresponding to a matching number included in the obtained second image information does not exist in the table 411, the processor 120 may be configured to send a request for a graphic object for the obtained second image information to the server and to store the graphic object received in response to the request in the table 411. The processor 120 delivers information received from the server 106 to an application of the electronic device 101, in which the application may be matched to a table exchanged in advance with the server 106 through a change of a shape of a mouse cursor. The processor 120 displays an image of the mouse cursor on the display 160.

Similar to the image information described above, the obtained second image information may include at least one of hotspot information and image type information, and the hotspot information may indicate information about a reference pixel of a graphic object corresponding to the obtained second image information. The image type information is identified by a form of an image of a cursor agreed to in advance between the electronic device 101 and the server 106, and may include various types such as an arrow type in which a left top is sharp, an arrow type in which an edge and a line are adjustable, a finger type, etc. For example, if the image type is a sharp left-top arrow type, hotspot information may be (0, 0); if the image type is an edge-and-line-adjustable arrow type, the hotspot information may be (20, 20); and if the image type is a finger type, the hotspot information may be (30, 30). The table may include at least one graphic object, hotspot information about each graphic object, and a matching number of each graphic object, depending on a type of the user input. The processor 120 may be configured to display the second image in relation to the first image at least based on the second image information through the display 160. The processor 120 is configured to decode the first image, to load the decoded first image on a first layer, to load the second image on a second layer, and to overlappingly display the loaded first layer and second layer on the display 160 in real time. The processor 120 generates screen information to be displayed on the display 160 by overlapping the second layer onto the loaded first layer, and displays the generated screen information.

The memory 420 of the server 106 stores a table 421 associated with a graphic object to be displayed on the display 160 of the electronic device 101. The table 421 may include at least one graphic object corresponding to matching information (or an identifier) included in image information to be transmitted to the electronic device 101. The table 421 may include at least one of at least one graphic object to be displayed on the display 160 of the electronic device 101, hotspot information regarding each graphic object, image type information, and a matching number (or an identifier) of each graphic object. The table 421 may include a cursor number of a mouse, a cursor image corresponding to the cursor number, and hotspot information of the cursor. For example, the table 421 may include information indicating a pressure (or strength) of a touch, a cursor image corresponding to the pressure, and hotspot information of the cursor. The table 421 may include different information according to the electronic device 101. The table 421 may include information included in the table 411 stored in the memory 130 of the electronic device 101.

The processor 430 of the server 106 may transmit image information corresponding to motion information received from the electronic device 101 and screen information of the server 106 to the electronic device 101 through the network 162. The processor 430 of the server 106 may generate image information corresponding to an image at least based on motion information received from the electronic device 101 and transmit the generated image information to the electronic device 101 through the network 162. The processor 430 of the server 106 reflects reception of the motion information from the electronic device 101 to an operation of an OS, and senses a shape of the mouse cursor changed in an OS or application of the server 106. The server 106 searches for information corresponding to the reflected operation in a table agreed to with the electronic device 101. In this way, the server 106 may minimize the amount of information to be transmitted to the electronic device 101. The server 106 transmits information to be reflected to the electronic device 101 through the network 162. The server 106 transmits a matching number of the mouse cursor matched or an image of the mouse cursor to the electronic device 101 in response to the received motion information.

The electronic device 101 according to an embodiment of the present disclosure includes a communication module, a memory configured to store a table related to a graphic object, a display, and a processor, in which the processor is configured to obtain a user input, to transmit motion information corresponding to the user input to an external electronic device using the communication module, to obtain image information corresponding to the motion information and screen information of the external electronic device from the external electronic device, to determine the graphic object based on the image information, and to display the graphic object and the screen information together.

The processor may be configured to obtain the user input through the display, and the user input may include at least one of a cursor generated by a cursor and a touch generated by the mouse.

If the user input is an input generated by the mouse, the motion information may include information about coordinates of the cursor, and if the user input is an input generated by the touch, the motion information may include information indicating a pressure generated by the touch.

The obtained image information may include a matching number for the graphic object to be displayed on the display based on the motion information.

The processor may be configured to determine a graphic object corresponding to a matching number included in the obtained image information from a table.

If a graphic object corresponding to a matching number included in the obtained image information does not exist in the table, the processor may be configured to send a request for a graphic object for the obtained image information to the server and to store the graphic object received in response to the request in the table.

The obtained image information may include at least one of hotspot information and image type information, and the hotspot information may indicate information about a reference pixel of a graphic object corresponding to the obtained image information.

The table may include at least one of at least one graphic object, hotspot information about each graphic object, and a matching number of each graphic object, depending on a type of the user input.

The processor may be configured to decode the obtained screen information, to load the decoded screen information on a first layer, to load the determined graphic object on a second layer, and to overlappingly display the loaded first layer and second layer on the display in real time.

The electronic device 101 according to an embodiment of the present disclosure includes a communication module, a memory, a display, and a processor, in which the processor is configured to send a request for at least one application to an external electronic device through the communication module, to receive first image information corresponding to a first image related to execution of the at least one application from the external electronic device, to display the first image generated at least based on the first image information through the display, to obtain a user input with respect to the displayed first image, to transmit motion information corresponding to the user input to an external electronic device, to receive second image information, which is generated at least based on the motion information and corresponds to a second image related to the user input, from the external electronic device, and to display the second image in relation to the first image at least based on the second image information through the display.

The processor may be configured to obtain the user input through the display, and the user input may include at least one of a cursor generated by a cursor and a touch generated by the mouse.

If the user input is an input generated by the mouse, the motion information may include information about coordinates of the cursor, and if the user input is an input generated by the touch, the motion information may include information indicating a pressure generated by the touch.

If a graphic object corresponding to a matching number included in the obtained second image information does not exist in the table, the processor may be configured to send a request for a graphic object for the obtained second image information to the server and to store the graphic object received in response to the request in the table.

The processor may be configured to generate the second image at least based on the second image information.

The obtained image information may include at least one of hotspot information and image type information, and the hotspot information may indicate information about a reference pixel of a graphic object corresponding to the obtained image information.

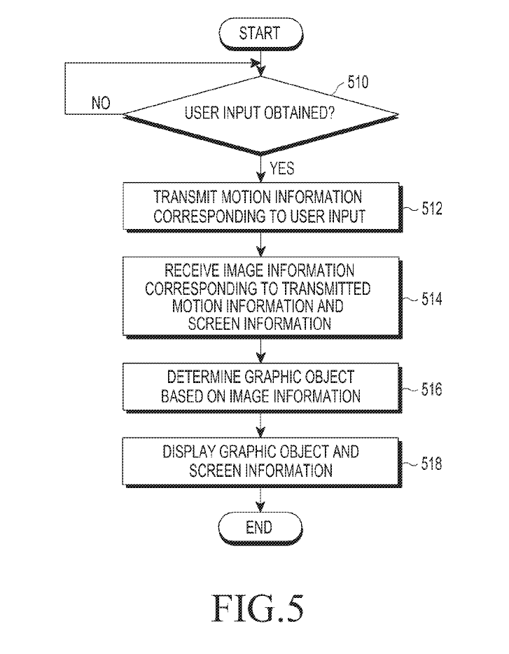

FIG. 5 is a flowchart of a process for controlling a display of an electronic device in response to a user input according to an embodiment of the present disclosure.

Once a user input is obtained in step 510, the electronic device 101 transmits motion information corresponding to the user input in step 512. The electronic device 101 connects to an external electronic device through the network 162 to obtain information of the external electronic device and display the obtained information on a display. For example, the electronic device 101 may connect to an external electronic device by using an application capable of connecting to the external electronic device, obtain an OS of the external electronic device and screen information of the application, and display the obtained OS and screen information on the display.

The electronic device 101 obtains a user input through the display 160 and transmits motion information corresponding to the user input to the external electronic device (e.g., the server 106) by using the communication module 170. The electronic device 101 delivers the obtained user information to the application without the processor 120 processing the obtained user information. The electronic device 101 may transmit coordinates information of a cursor to the external electronic device without directly displaying a motion of the cursor corresponding to the input user information on the display. The electronic device 101 may be configured to obtain a user input through the display 160, and the user input may include at least one of a cursor and a touch generated through the mouse. The electronic device 101 obtains a user input based on a user's touch through the display 160 or obtains a user input through the mouse connected to the I/O interface 150. The electronic device 101 obtains an input generated by the cursor and an input generated by the touch generated through the mouse at the same time. For example, if the user input is an input generated by the mouse, the motion information may include information about coordinates of the cursor moving on the display 160, and if the user input is an input made through a touch, the motion information may include information indicating a pressure generated by the touch on the display 160. The electronic device 101 obtains information about coordinates of the cursor moving in real time in response to a motion of the cursor. If the touch on the display 160 is input, the electronic device 101 senses a touched point and a pressure at the touched point (e.g., a touch pressure) and obtains coordinates information and pressure values corresponding to the sensing. The motion information may include not only a user input made using a motion of a cursor and a pressure of a touch, but also various signals (e.g., a user's biometric signal, an external signal, etc.) input to control the electronic device 101. The electronic device 101 transmits motion information corresponding to the obtained user input to the server 106. The server 106 may transmit image information corresponding to the motion information received from the electronic device 101 and screen information of the server 106 to the electronic device 101 through the network 162. The server 106 may generate image information corresponding to an image at least based on the motion information received from the electronic device 101 and transmit the generated image information to the electronic device 101 through the network 162.

The electronic device 101 receives image information and screen information corresponding to the transmitted motion information in step 514 and determines a graphic object based on the image information in step 516. The electronic device 101 obtains image information corresponding to the motion information transmitted to the server 106 and screen information of the server 106 from the server 106, and determines the graphic object based on the image information. The processor 101 then displays the graphic object and the screen information on the display 160 together. The image information obtained from the server 106 may include a matching number for a graphic object to be displayed on the display 160 based on the transmitted motion information. The image information may include at least one of at least one graphic object, hotspot information regarding each graphic object, image type information, and a matching number (or an identifier) of each graphic object, depending on a type of a user input inputted through the display 160.

The electronic device 101 may be configured to determine a graphic object corresponding to a matching number included in the obtained image information from a table. The electronic device 101 selects a corresponding graphic object from the table based on at least one of at least one graphic object, hotspot information regarding each graphic object, and a matching number of each graphic object. For example, if a graphic object corresponding to a matching number included in the obtained image information does not exist in the table, the electronic device 101 may be configured to send a request for a graphic object for the obtained image information to the server and to store the graphic object received in response to the request in the table.

The electronic device 101 displays the graphic object and the screen information in step 518. The electronic device 101 may determine the graphic object based on the image information and to display the graphic object and the screen information together. The electronic device 101 may decode screen information obtained in response to the user input, load the decoded screen information on a first layer, load the determined graphic object on a second layer, and overlappingly display the loaded first layer and second layer on the display in real time. The electronic device 101 generates screen information to be displayed on the display 160 by overlapping the second layer onto the loaded first layer, and displays the generated screen information.

A method for controlling a display in response to a user input in an electronic device according to an embodiment of the present disclosure includes transmitting motion information corresponding to a user input to an external electronic device, obtaining image information corresponding to the motion information and screen information of the external electronic device, determining the graphic object based on the image information, and displaying the graphic object and the screen information together.

The method may further include determining whether the user input is an input generated by a mouse or an input generated by a touch, in which if the user input is the input generated by the mouse, the motion information includes information about coordinates of the cursor, and if the user input is the input generated by the touch, the motion information includes information indicating a pressure generated by the touch.

The method may further include determining a graphic object corresponding to a matching number included in the obtained image information from a previously stored table.

The method may further include sending a request for a graphic object for the obtained image information to the server and storing the graphic object received in response to the request in the table, if a graphic object corresponding to a matching number included in the obtained image information does not exist in the table.

The displaying of the graphic object and the screen information together may include decoding the obtained screen information and loading the decoded screen information on a first layer in response to the obtained user input, loading the determined graphic object on a second layer, and overlappingly displaying the loaded first layer and the second layer on the display in real time.

The method may further include sending a request for at least one application to the external electronic device and displaying an image related to execution of at least application corresponding to the request.

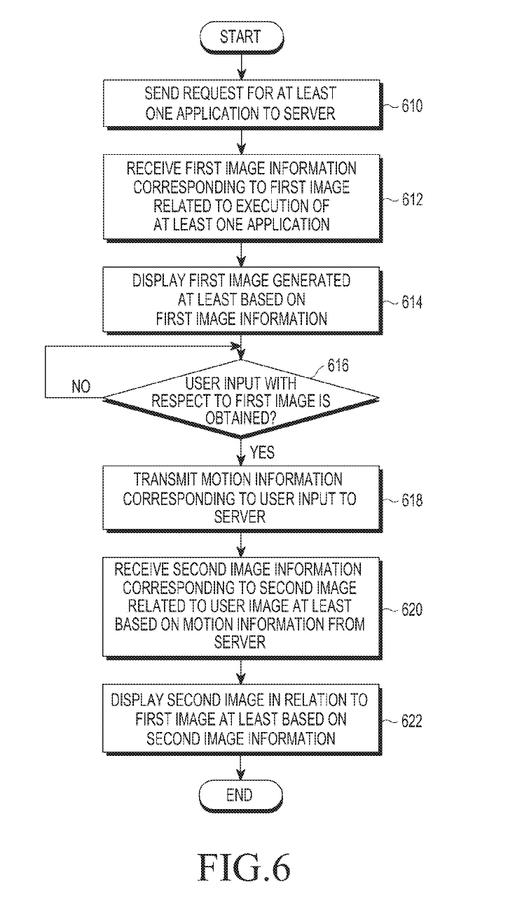

FIG. 6 is a flowchart of a process for controlling a display of an electronic device in response to a user input according to an embodiment of the present disclosure.

The electronic device 101 sends a request for at least one application to the server in step 610 and receives first image information corresponding to a first image related to execution of the at least one application in step 612. The electronic device 101 sends a request for at least one application to an external electronic device (e.g., the server 106) through the communication interface 170 and receives first image information corresponding to a first image related to execution of the at least one application from the server 106. The electronic device 101 sends a request for at least one application to be executed in the electronic device 101 to the server 106 and receives first image information corresponding to a first image related to execution of the requested application from the server 106. The application is provided from the server 106, and the user of the electronic device 101 connects to the server 106 through the application and controls the server 106. The server 106 controls the electronic device 101 through the application.

The electronic device 101 displays the first image generated at least based on the first image information in step 614. The electronic device 101 displays an application received from the server 106 on the display 160.

Once a user input with respect to the first image is obtained in step 616, the electronic device 101 transmits motion information corresponding to the user input to the server in step 618, and receives second image information corresponding to a second image related to the user input from the server at least based on the motion information in step 620. The electronic device 101 obtains a user input inputted on the first image displayed on the display 160 and transmits motion information corresponding to the user input to the server 106 by using the communication interface 170. The electronic device 101 obtains a user input based on a user's touch through the display 160 or obtains a user input through the mouse connected to the I/O interface 150. The electronic device 101 obtains an input generated by the cursor and an input generated by the touch generated through the mouse at the same time. For example, if the user input is an input generated by the mouse, the motion information may include information about coordinates of the cursor moving on the display 160, and if the user input is an input generated by the touch, the motion information may include information indicating a pressure generated by the touch on the display 160. The electronic device 101 obtains information about coordinates of the cursor moving in real time in response to a motion of the cursor. If the touch on the display 160 is input, the electronic device 101 senses a touched point and a pressure at the touched point (e.g., a touch pressure) and obtains coordinates information and pressure values corresponding to the sensing. The motion information may include not only a user input made using a motion of a cursor and a pressure of a touch, but also various signals (e.g., a user's biometric signal, an external signal, etc.) input to control the electronic device 101.

The electronic device 101 transmits motion information corresponding to the obtained user input to the server 106. The server 106 transmits the second image information corresponding to the second image corresponding to the motion information received from the electronic device 101 to the electronic device 101 through the network 162. The server 106 may generate the second image information corresponding to the second image at least based on the motion information received from the electronic device 101 and transmit the generated second image information to the electronic device 101 through the network 162. The electronic device 101 receives the second image information corresponding to the second image. The electronic device 101 determines a graphic object at least based on the second image information, upon receiving the second image information corresponding to the second image. The electronic device 101 obtains the second image information corresponding to the transmitted motion information from the server 106 and determines the graphic object based on the second image information.

The electronic device 101 displays the second image in relation to the first image at least based on the second image information in step 622. The electronic device 101 then displays the second image together with the first image on the display 160. The second image information obtained from the server 106 may include a matching number for a graphic object to be displayed on the display 160 based on the transmitted motion information. The second image information may include at least one of at least one graphic object, hotspot information regarding each graphic object, image type information, and a matching number (or an identifier) of each graphic object, depending on a type of a user input inputted through the display 160.

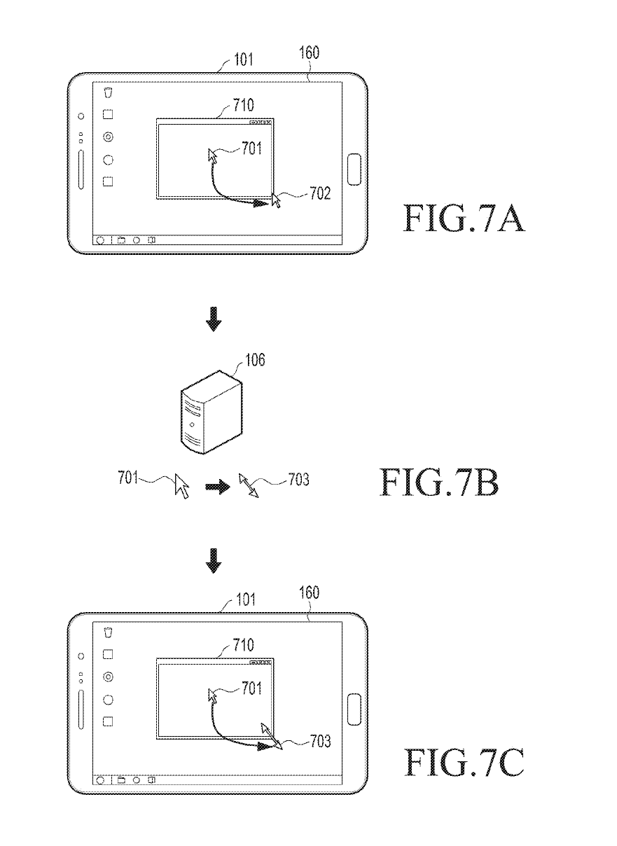

FIGS. 7A through 7C are views showing controlling a display of an electronic device in response to a user input according to an embodiment of the present disclosure; FIG. 7A illustrates movement of a mouse cursor on a display of an electronic device, FIG. 7B illustrates generation of image information corresponding to motion information of a mouse cursor moved in an electronic device by a server, and FIG. 7C illustrates a screen displaying image information received from a server.

Referring to FIGS. 7A through 7C, the electronic device 101 obtains a user input through the display 160. The electronic device 101 determines a current location of a mouse cursor 701 on an application 710. The electronic device 101 senses a motion of the mouse cursor 701 on the application 710 and determines a location of a mouse cursor 702 after the motion. The electronic device 101 obtains coordinates of the cursor moving in real time in response to the motion of the cursor. For example, the electronic device 101 may generate motion information (e.g., coordinates information) by obtaining the location of the moving mouse cursor. The electronic device 101 determines a current location of the mouse cursor 701 on the application 710. The electronic device 101 senses a touch on the application 710 and determines coordinates of a touch-sensed point. For example, the electronic device 101 may generate motion information of the sensed point (e.g., information indicating a pressure of the touch). The electronic device 101 obtains an input generated by the cursor and an input generated by the touch through the mouse at the same time. For example, if the user input is an input generated by the mouse, the motion information may include information about coordinates of the cursor moving on the display 160, and if the user input is an input made through the touch, the motion information may include information indicating a pressure generated by the touch on the display 160. The electronic device 101 transmits the motion information to the server 106 in real time. The motion information may include not only a user input made using a motion of a cursor and a pressure of a touch, but also various signals (e.g., a user's biometric signal, an external signal, etc.) input to control the electronic device 101.

As shown in FIG. 7B, the server 106 may transmit image information corresponding to motion information received from the electronic device 101 to the electronic device 101 through the network 162. The server 106 may generate image information corresponding to an image at least based on motion information received from the electronic device 101 and transmit the generated image information to the electronic device 101 through the network 162. For example, the server 106 may transmit a matching number corresponding to an image 703 of a cursor corresponding to the motion information based on the table 421 stored in the memory 420 of the server 106 to the electronic device 101.

As shown in FIG. 7C, the electronic device 101 receives image information (e.g., a matching number) corresponding to the transmitted motion information and determines a graphic object (e.g., the image of the cursor) based on the image information. The electronic device 101 also displays the image of the cursor on the application 710. The image information obtained from the server 106 may include a matching number for a graphic object to be displayed on the display 160 based on the transmitted motion information. For example, if a graphic object corresponding to a matching number included in the obtained image information does not exist in the table, the electronic device 101 may send a request for a graphic object for the obtained image information to the server and store the graphic object received in response to the request in the table. The electronic device 101 may determine the graphic object based on the image information and display the graphic object and the screen information together.

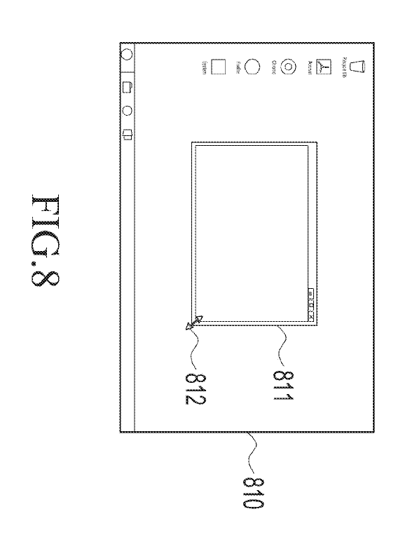

FIG. 8 illustrates a process of displaying a graphic object and screen information according to an embodiment of the present disclosure.

Referring to FIG. 8, the electronic device 101 decodes obtained screen information 811, loads the decoded screen information on a first layer, loads a graphic object 812 on a second layer, and overlappingly displays the loaded first layer and second layer on a display 810 in real time. The electronic device 101 generates screen information to be displayed on the display 810 by overlapping the second layer onto the loaded first layer, and displays the generated screen information on the display 810. The electronic device 101 may synthesize the first layer with the second layer and store a synthesis result in a frame buffer, and then finally display the synthesis result on the display 810. The electronic device 101 receives first image information corresponding to the first image related to execution of at least one application from the server 106, displays the first image generated at least based on the first image information 811 through the display 810, and obtains a user input with respect to the displayed first image. The electronic device 101 transmits motion information corresponding to the user input to the server 106, receives second image information, which is generated at least based on the motion information and corresponds to second image information corresponding to the second image related to the user input, from the external electronic device, and displays the second image 812 through the display in relation to the first image at least based on the second image information.

A term “module” used herein may mean, for example, a unit including one of or a combination of two or more of hardware, software, and firmware, and may be used interchangeably with terms such as logic, a logic block, a part, or a circuit. The “module” may be a part configured integrally, a minimum unit or a portion thereof performing one or more functions. The “module” may be implemented mechanically or electronically, and may include an application-specific integrated circuit (ASIC) chip, field-programmable gate arrays (FPGAs), and a programmable-logic device performing certain operations already known or to be developed. At least a part of an apparatus (e.g., modules or functions thereof) or a method (e.g., operations) according to various embodiments may be implemented with an instruction stored in a computer-readable storage medium (e.g., the memory 130) in the form of a programming module. When the instructions are executed by a processor (for example, the processor 120), the processor may perform functions corresponding to the instructions.

According to various embodiments, by transmitting and receiving information of a system level between heterogeneous OSs in cloud computing, the user may experience minimum latency. Moreover, even the electronic device recognizes a change of a system level of the server, providing an experience like using an application of the server to the user through the electronic device.

According to various embodiments, there is provided a storage medium having stored therein instructions which may include a first instruction set for transmitting motion information corresponding to a user input to an external electronic device, a second instruction set for obtaining image information corresponding to the motion information and screen information of the external electronic device, a third instruction set for determining the graphic object based on the image information, and a fourth instruction set for displaying the graphic object and the screen information together.

The computer-readable recording medium includes hard disk, floppy disk, or magnetic media (e.g., a magnetic tape, optical media (e.g., compact disc read only memory (CD-ROM) or digital versatile disc (DVD), magneto-optical media (e.g., floptical disk), an embedded memory, and so forth. The instructions may include a code generated by a compiler or a code executable by an interpreter. Modules or programming modules according to various embodiments of the present disclosure may include one or more of the foregoing elements, have some of the foregoing elements omitted, or further include additional other elements. Operations performed by the modules, the programming modules or other elements according to various embodiments may be executed in a sequential, parallel, repetitive or heuristic manner, or at least some of the operations may be executed in different orders, and may be omitted, or other operations may be added.

The embodiments disclosed in the present specification and drawings have been provided to describe the present disclosure and to help understanding of the present disclosure, and are not intended to limit the scope of the present disclosure. Therefore, it should be construed that the scope of the present disclosure includes any change or other various embodiments based on the technical spirit of the present disclosure as well as the embodiments described herein.

What is claimed is:

1. An electronic device comprising:
a memory configured to store a table related to a graphic object;
a display; and
a processor configured to:
obtain a user input,
transmit motion information corresponding to the user input to an external electronic device,
obtain image information corresponding to the motion information and screen information of the external electronic device from the external electronic device,
determine the graphic object based on the image information, and
display the graphic object and the screen information together.

2. The electronic device of claim 1, wherein the processor is further configured to obtain the user input through the display, and
Wherein the user input comprises at least one of a cursor by a mouse and a touch on the display.

3. The electronic device of claim 2, wherein if the user input is an input by the mouse, the motion information comprises coordinates information of the cursor, and
wherein if the user input is an input by the touch on the display, the motion information comprises information indicating a pressure by the touch.

4. The electronic device of claim 1, wherein the obtained image information comprises a matching number for the graphic object to be displayed on the display based on the motion information.

5. The electronic device of claim 1, wherein the processor is further configured to determine a graphic object corresponding to a matching number included in the obtained image information from the table.

6. The electronic device of claim 5, wherein if the graphic object corresponding to a matching number included in the obtained image information does not exist in the table, the processor is further configured to send a request for a graphic object for the obtained image information to the external electronic device and to store the graphic object received in response to the request in the table.

7. The electronic device of claim 1, wherein the obtained image information comprises at least one of hotspot information and image type information, and
wherein the hotspot information indicates information about a reference pixel of a graphic object corresponding to the obtained image information.

8. The electronic device of claim 1, wherein the table comprises at least one of at least one graphic object, hotspot information about each graphic object, and a matching number of each graphic object, depending on a type of the user input.

9. The electronic device of claim 1, wherein the processor is further configured to:
decode the obtained screen information and load the decoded screen information on a first layer on the display in response to the obtained user input;
load the determined graphic object on a second layer on the display; and
overlappingly display the loaded first layer and the second layer on the display in real time.

10. A method for controlling a display in response to a user input in an electronic device, the method comprising:
transmitting motion information corresponding to a user input to an external electronic device;
obtaining image information corresponding to the motion information and screen information of the external electronic device;
determining a graphic object based on the image information; and
displaying the graphic object and the screen information together.

11. The method of claim 10, further comprising determining whether the user input is an input by a mouse or an input by a touch on the display,
wherein if the user input is the input by the mouse, the motion information comprises information about coordinates of the cursor, and if the user input is the input by the touch, the motion information comprises information indicating a pressure by the touch.

12. The method of claim 10, further comprising determining a graphic object corresponding to a matching number included in the obtained image information from a previously stored table.

13. The method of claim 12, further comprising sending a request for a graphic object for the obtained image information to the external electronic device and storing the graphic object received in response to the request in the table, if a graphic object corresponding to a matching number included in the obtained image information does not exist in the table.

14. The method of claim 10, wherein displaying the graphic object and the screen information together comprises:
decoding the obtained screen information and loading the decoded screen information on a first layer on the display in response to the user input;
loading the determined graphic object on a second layer on the display; and
overlappingly displaying the loaded first layer and the second layer on the display in real time.

15. The method of claim 10, further comprising:
sending a request for at least one application to the external electronic device; and
displaying an image related to execution of the at least one application corresponding to the request.

16. An electronic device comprising:
a communication interface;
a memory;
a display; and
a processor configured to:
send a request for at least one application to an external electronic device through the communication interface,
receive first image information corresponding to a first image related to execution of the at least one application from the external electronic device,
display the first image generated at least based on the first image information through the display,
obtain a user input with respect to the displayed first image,
transmit motion information corresponding to the user input to the external electronic device,
receive second image information, which is generated at least based on the motion information and corresponds to a second image related to the user input, from the external electronic device, and
display the second image in relation to the first image at least based on the second image information through the display.

17. The electronic device of claim 16, wherein the processor is further configured to obtain the user input through the display, and
wherein the user input comprises at least one of a cursor by a mouse and a touch on the display.

18. The electronic device of claim 16, wherein if a graphic object corresponding to a matching number included in the received image information does not exist in a table stored in advance in the memory, the processor is further configured to send a request for a graphic object for the received second image information to the external electronic device and to store the graphic object received in response to the request in the table.

19. The electronic device of claim 16, wherein the processor is further configured to generate the second image at least based on the second image information.

20. The electronic device of claim 16, wherein the received image information comprises at least one of hotspot information and image type information, and
wherein the hotspot information indicates information about a reference pixel of a graphic object corresponding to the received image information.
